(19) United States
(12) Patent Application Publication
(10) Pub. No.: US 2026/0192509 A1
(43) Pub. Date: Jul. 9, 2026

(54) A COMPONENT AND METHOD OF FORMATION OF A COMPONENT

(71) Applicant: Victrex Manufacturing Limited, Thornton Cleveleys, Lancashire (GB)

(72) Inventors: Adam Chaplin, Thornton Cleveleys, Lancashire (GB); Richard Davies, Exeter, Devon (GB); Oana Ghita, Exeter, Devon (GB)

(21) Appl. No.: 19/129,817

(22) PCT Filed: Nov. 6, 2023
(86) PCT No.: PCT/GB2023/052891

§ 371 Date: May 14, 2025

(30) Foreign Application Priority Data
Nov. 14, 2022 (GB) 2216920.5

(51) Int. Cl. B29C 64/118; B29K 71/00; B33Y 10/00; B33Y 80/00; C08J 5/12; C08J 5/24; C09J 5/06; C09J 171/00

(52) U.S. Cl. CPC B29C 64/118; B33Y 10/00; B33Y 80/00; C08J 5/128; C08J 5/243; C09J 5/06; C09J 171/00; B29K 2071/00; C08J 2371/08; C08J 2471/08; C09J 2471/008

(57) ABSTRACT

A method of forming a component having a structure bonded to a composite part formed from prepreg tape or sheet having fibres within a matrix of thermoplastic polymer involves printing multiple layers of a feedstock material comprising at least 60 % by weight of thermoplastic polymer onto the composite part to form the structure. At least the first layer of the structure is printed with the feedstock material at a temperature in excess of the melting temperature of the prepreg polymer. The method provides strong melt-bonding of the structure to the composite part. A component having a structure of sequentially printed layers melt-bonded to a composite part is also provided.

This invention relates to components, and to methods of forming components, in which a structure is directly formed by printing feedstock onto a composite part formed from one or more layers of prepreg tape or sheet having fibres within a matrix of thermoplastic polymer. The method provides strong melt-bonding of the structure to the composite part through melting and co-mingling of the thermoplastic polymer of the prepreg tape or sheet and the thermoplastic polymer of the feedstock material followed by re-solidification. This facilitates the formation of components having shapes which would otherwise be difficult or wasteful to form by means of conventional component shaping from prepreg layers alone by thermoforming, compression moulding or automated tape laying.

Composite parts are typically formed by thermoforming, compression moulding or automated tape laying of one or more layers of prepreg tape or sheet. Each prepreg tape or sheet used to form such a composite part comprises fibres held within a matrix of thermoplastic polymer. The fibres are typically in the form of unidirectional fibre rovings, woven fabric or non-woven fabric, impregnated with thermoplastic polymer in a molten state and calendared into the prepreg sheets or tape. Such prepreg tape or sheet will typically have from 45% to 65% by volume of fibre, with the remainder being the thermoplastic polymer matrix with less than 10% by volume, such as 2% or less, or 0.2% or less, being pores or voids (typically air voids). The term prepreg as used herein refers to such materials—it is a contraction of the term “pre-impregnated” and refers to a fibre-reinforced polymer material where the fibre reinforcing material is pre-impregnated with polymer.

Polyaryletherketones (PAEKs), such as the homopolymers polyetheretherketone (PEEK), polyetherketone (PEK) polyetherketoneketone (PEKK) or copolymers such as polyetherketone/polyetherdiphenyletherketone (PEEK/PEDEK) are high performance, semi-crystalline thermoplastic polymers which have melting temperatures from 320° C. to 400° C. and are useful as matrix polymers for thermoplastic composites. Hence such thermoplastic polymers are useful as the matrix polymers of prepreg sheets or tapes.

Other suitable thermoplastic polymers include polyethylenes, polypropylenes, polycarbonates, polyamides, polyethylene terephthalates, polyphenylene sulfides and polyetherimides.

The reinforcement fibres may be carbon, aramid, glass or the like and may be continuous fibres or discontinuous fibres.

In recent years, a number of industries, for instance the aerospace industry, have moved to greater adoption of thermoplastic composites formed from prepregs due to the ease and speed of fabrication and the ability to combine sub-components into modular systems. One technique which has been developed is that of overmoulding composite components formed from prepreg with structures formed by injection moulding of polymers. This enables relatively simply shaped planar or curved composite parts formed from thermoplastic polymer prepreg to be provided with additional structural features which would be otherwise difficult or impossible to achieve through conventional processing of prepreg.

It is also known to make components by use of adhesives such as epoxy resins to adhesively bond an additional structure onto a composite part formed from prepreg. However, there are disadvantages with this approach, including undesirably long setting times; preparation of surfaces prior to adhesive bonding; sensitivity of bond strength to ambient conditions; chemical resistance and mechanical durability of the adhesive bond.

One object of the invention is to address the problems set out above. It is also an object of the invention to provide a method for producing a component comprising a structure secured to a fibre-reinforced composite part by forming a melt bond so that the melt bond has excellent chemical resistance and long term mechanical properties.

Throughout this specification, the term “comprising” or “comprises” means including the component(s) specified but not to the exclusion of the presence of other components.

The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding other components.

Whenever appropriate, depending upon the context, the use of the term “comprises” or “comprising” may also be taken to include the meaning “consists essentially of” or “consisting essentially of”, and may also be taken to include the meaning “consists of” or “consisting of”.

A first aspect of the invention provides a method of forming a component having a structure bonded to a composite part, wherein the composite part is a part formed of one or more layers of consolidated prepreg tape or sheet, wherein each prepreg tape or sheet comprises fibres within a matrix of thermoplastic polymer, the method comprising the following steps:
a) selecting a feedstock material comprising 60 to 100% by weight of feedstock thermoplastic polymer, preferably 70 to 100% by weight of feedstock thermoplastic polymer;
b) extruding the feedstock material through an exit orifice of a printing head to form a first layer of the structure printed onto an outer layer of prepreg tape or sheet of the composite part, with the feedstock polymer in a molten state and at a first printing temperature T1 at the exit orifice; and
c) extruding the feedstock material through the exit orifice to form a second layer and subsequent layers of the structure, with the second and subsequent layers printed onto a respective preceding layer of the structure, until the structure is complete, with the feedstock polymer in a molten state at the exit orifice at a subsequent printing temperature;
wherein T1 is greater than the melting temperature, Tm, of the thermoplastic polymer of the matrix of the outer layer of prepreg tape or sheet of the composite component so that at least a portion of the thermoplastic polymer of the matrix of the outer layer of prepreg tape or sheet is melted by contact with the first layer of the structure to form a melt-bond between the first layer of the structure and the outer layer of prepreg tape or sheet.

The term composite part, as used herein, refers to a part which comprises fibres reinforcing a matrix of thermoplastic polymer, and is formed of one or more layers of consolidated prepreg tape or sheet, wherein each prepreg tape or sheet comprises fibres within a matrix of thermoplastic polymer. The composite part comprises, preferably consists of, one or more layers of consolidated prepreg tape or sheet.

Consolidation of the prepreg tapes or sheets making up the composite part may typically be achieved by heating and application of pressure to prepreg sheets placed in mutual contact whereby melt-bonds are formed between adjacent sheets. Automated tape laying may be used for sheet or tape placement and thermoforming and/or compression moulding, for instance in an autoclave, may be used to provide consolidated sheets. The composite part may be planar or may be formed into a non-planar shape. The reference to one or more layers of consolidated prepreg tape or sheet includes one layer of prepreg tape or sheet or a plurality of layers of consolidated prepreg tape or sheet.

The composite part may be shaped, for instance, by thermoforming. This may be achieved, for instance, by shaping over or within a mould, including compression moulding or moulding in an autoclave arrangement, in which case consolidation and moulding may be carried out together.

Such composite parts and their formation by consolidation of one or more layers of prepreg tape or sheet are well known and described, for instance, in “Mechanical characterisation of carbon fibre-PEEK manufactured by laser-assisted automated-tape-placement and autoclave” by A. J. Comer et al, Composites: Part A 69 (2015) 10-20.

The composite part may be formed from layers of prepreg tape or sheet which differ from each other in composition, but preferably each layer of prepreg tape or sheet of the composite part has the same composition as the outer layer.

The manufacture of prepreg is described, for instance, in “Manufacture of high performance fibre-reinforced thermoplastics by aqueous powder impregnation” by A. M Vordermeyer et al.—Composites Manufacturing Vol. 4 No. 3 1993 and in U.S. Pat. No. 5,888,580 and patent application publications such as EP 3446845A1, WO2018/234436A1, EP 2725055A1 and EP3418323A1.

The prepreg tape or sheet will typically have from 45% to 65% by volume of fibre, with the remainder being the thermoplastic polymer matrix with less than 10% by volume, such as 2% or less, or 0.2% or less, being pores or voids (typically air voids). The prepreg sheet may contain also further components, typically at a level of 5% by weight or less, within the thermoplastic polymer matrix.

The thermoplastic polymer of the matrix of the outer layer of the prepreg sheet or tape will exhibit a melting temperature Tm measured by differential scanning calorimetry (DSC) as described below. Any further components which are present in the prepreg and are miscible with the thermoplastic polymer of the matrix are included when measuring Tm.

The fibre of the prepreg sheet or tape has a melting temperature which is higher than that of the Tm of the thermoplastic polymer of the matrix, preferably by 100° C. or more.

The structure bonded to the composite part is formed from a feedstock material comprising 60 to 100% by weight of feedstock thermoplastic polymer, preferably 70 to 100% by weight of feedstock thermoplastic polymer. The remainder of the feedstock material may include filler, such as inorganic solid, and/or other components. Any other components of the feedstock material which miscible or compatible with the thermoplastic feedstock polymer are included when measuring the melting temperature of the thermoplastic feedstock polymer.

The incorporation of fillers in the feedstock material may be beneficial, for instance to reduce the level of shrinkage on solidification of the extruded feedstock material present in the structure. Other benefits of incorporating filler into the feedstock material may including imparting new and desirable mechanical, electrical, tribological, aesthetic, manufacturability, chemical adhesion, hydrophobicity/hydrophilicity, density, identification, and thermal properties to the printed structure.

The filler may comprise fibrous filler and/or non-fibrous filler.

Fibrous filler may be continuous fibrous filler or discontinuous fibrous filler.

Suitably, the melting temperature for any filler is in excess of the melting temperature of the feedstock thermoplastic polymer, for instance at least 450° C.

Filler may be present from 0% to 30% by weight, such as from 7 to 25% by weight.

One or more fillers may be selected from glass fibre, carbon fibre, asbestos fibre, silica fibre, para-aramid fibre, Kevlar fibre, ceramic fibre, alumina fibre, zirconia fibre, boron nitride fibre, silicon nitride fibre, boron fibre, fluorocarbon resin fibre and potassium titanate fibre, mica, silica, talc, hydroxyapatite, alumina, kaolin, calcium sulfate, calcium carbonate, titanium oxide, titanium dioxide, zinc sulphide, ferrite, clay, glass powder, zinc oxide, nickel carbonate, iron oxide, quartz powder, magnesium carbonate, fluorocarbon resin, graphite, graphene, carbon powder, nanotubes, nanofibres and barium sulphate.

In a preferred embodiment, filler may comprise or be discontinuous carbon fibre having a nominal length from 50 to 800 microns, more preferably 60 to 150 microns.

The structure is formed by extruding the feedstock material through an exit orifice of a printing head to form a first layer of the structure printed onto an outer layer of prepreg tape or sheet of the composite part, with the feedstock polymer in a molten state, and at a first printing temperature T1 at the exit orifice, followed by extruding further feedstock material through the exit orifice to form a second layer and subsequent layers of the structure, with the second and subsequent layers printed onto a respective preceding layer of the structure, until the structure is complete. Throughout the printing of the structure, the feedstock polymer is maintained in a molten state at the exit orifice at a subsequent printing temperature, but for the second and subsequent layers, the temperature may be less than T1, the temperature used for printing the first layer.

The printing of a structure in this manner is suitably carried out in the manner set out in international patent application publication WO2021/205159 A1 and referred to as Fused Deposition Modelling™ (FDM), also known as fused filament fabrication (FFF). The feedstock material may be in the form of a filament on a reel which is fed into a heated printing head, which is movable in a number of different directions. The feedstock is extruded from an exit orifice of the printing head, as the printing head moves, in order to build up the printed structure. In other embodiments, feedstock material may be supplied as short filaments, rods, pellets or granules. The feedstock material in such form may be placed in a feedstock hopper and fed through an extruder to a printing head.

In some cases, two or more different feedstocks may be printed selectively. For instance, one of the feedstocks may be a support material which is needed only at locations above which an overhanging part of the structure is to be printed and requires support during the subsequent printing procedure. The support material can be removed subsequently, for instance by dissolution in a solvent or chemical reaction. Breakaway supports may also be used where the support structure is mechanically removed after printing. The feedstock material of the first aspect of the invention is the material forming the structure after any support material is removed.

The melting temperature (Tm) of the thermoplastic polymer of the matrix of the outer layer of the is suitably determined using the following DSC method.

A sample of the outer layer 8 mg (±3 mg) is scanned by DSC (differential scanning calorimetry) as follows:
Step 1 Perform and record a preliminary thermal cycle by heating the sample from 50° C., to a temperature at which the polymer is molten, at 20° C./min.
Step 2 Hold at this temperature for 5 minutes.
Step 3 Cool at 50° C./min to a point halfway between the Tg¹ and Tm¹ as recorded in the first cycle (Tg¹ is the point of greatest slope obtained during the glass transition on heating in step 1. The Tm¹ is the temperature at which the highest temperature peak of the melting endotherm reaches a maximum value in step 1).
Step 4 Hold for 3 hours
Step 5 Cool at 50° C./min to 50° C. and hold for 5 minutes
Step 6 Re-heat from 50° C. to a temperature at which the polymer is molten at 20° C./min, recording the Tm for this second heating endotherm (the temperature at which the highest temperature peak of the melting endotherm reaches a maximum value).

For PAEKs, the maximum temperature employed, at which the polymer is molten will typically be 400° C. For other polymers, a lower temperature may be employed.

Where the melting endotherm exhibits multiple peaks, Tm is taken as the maximum value at the peak of highest temperature. The measurement is carried out below the melting temperature of the fibres of the outer layer of the prepreg tape or sheet.

In other words, Tm is the temperature at which the highest temperature peak of the melting endotherm reaches a maximum value when measured by DSC using a heating rate of 20° C. after first melting and cooling the polymer.

The same method is also suitable used for measurement of the melting temperature of the feedstock thermoplastic polymer.

Preferably, when carrying out the method of the first aspect of the invention, the outer layer of prepreg tape or sheet of the composite part is at a temperature from (Tm−140) ° C. to (Tm−40) ° C. This feature means that the outer layer has a temperature which is close enough to Tm to ensure formation of a melt-bond arising from the printing of the first layer at a temperature T1, but not so close to Tm that the composite part may deform.

T1 is preferably greater than Tm by 20° C. or more and less than the thermal decomposition onset temperature of the feedstock thermoplastic polymer by 20° C. or more. This feature means that the first printed layer has a temperature which sufficiently greater than Tm to ensure formation of a melt-bond arising from the printing of the first layer at a temperature T1, but not so high that the feedstock thermoplastic polymer will decompose.

The thermal decomposition onset temperature of the feedstock thermoplastic polymer is suitably assessed as the temperature (in ° C.) at which 0.1 weight % of the polymer mass is lost when a sample of the polymer is held for 10 minutes at that temperature. The value is suitably measured by means of thermal gravimetric analysis (TGA), for instance using a TA instruments TGA Q5000 with tared platinum plans in air. The temperature of a sample is first raised from room temperature up to 1000° C. at a rate of 50° C. per minute to assess the rough temperature by which 0.1% weight loss from the sample has been detected. Further samples can then be measured by holding each fresh sample, for 10 minutes, at one of a series of temperatures below the rough assessment to accurately assess the thermal decomposition onset temperature.

Preferably, the feedstock thermoplastic polymer has a melting temperature which is lower than Tm. This feature allows for low energy printing of the subsequent layers, after the printing of the first layer, which may result in improved crystallinity.

Preferably, the feedstock thermoplastic polymer and the thermoplastic polymer of the matrix of the outer layer of prepreg tape or sheet are compatible or miscible. Preferably they are miscible.

Polymer miscibility and compatibility as used herein are as defined in the IUPAC Compendium of Chemical Terminology, second edition 1997, so that a compatible polymer blend is a blend of immiscible polymers which, although present in separate phases in the blend, exhibits macroscopically uniform physical properties, whereas a miscible polymer blend forms a single phase with the polymers mixed on a molecular scale, as may be confirmed by may be confirmed by light scattering, X-ray scattering and neutron scattering.

The thermoplastic polymer of the matrix of the outer layer of prepreg tape or sheet is suitably a polyaryletherketone, PAEK polymer or a blend of PAEK polymers. The thermoplastic polymer of the matrix may suitably be a polyetheretherketone, PEEK, homopolymer or may suitably be a polyetheretherketone/polyetherdiphenyletherketone copolymer, in other words a PEEK/PEDEK copolymer.

The feedstock thermoplastic polymer is suitably a polyaryletherketone, PAEK polymer or a blend of PAEK polymers. The feedstock thermoplastic polymer may suitably be a polyetheretherketone/polyetherdiphenyletherketone copolymer, in other words a PEEK/PEDEK copolymer, or may suitably be a polyetheretherketone, PEEK, homopolymer.

Preferably, the thermoplastic polymer of the matrix of the outer layer of prepreg tape or sheet is a polyaryletherketone, PAEK polymer or a blend of PAEK polymers and the feedstock thermoplastic polymer is a polyaryletherketone, PAEK polymer or a blend of PAEK polymers.

PEEK/PEDEK copolymer is a copolymer comprising repeat units of formula

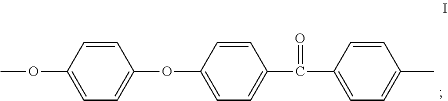

and repeat units of formula

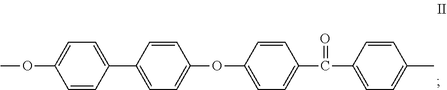

wherein at least 95 mol % of the copolymer repeat units, preferably all repeat units, are repeat units of formula I and of formula II. The polymer chain end groups may be groups derived from formula I and of formula II or may be other end groups as known in the art.

Preferably, the repeat units I and II have a molar ratio 1:11 from 60:40 to 80:20.

PEEK, homopolymer is a homopolymer comprising repeat units of formula I

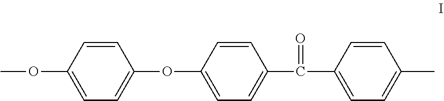

wherein at least 95 mol % of the copolymer repeat units, preferably all repeat units, are repeat units of formula I. The polymer chain end groups may be groups derived from formula I or may be other end groups as known in the art.

It has been found that such PEEK/PEDEK copolymer as feedstock has a high thermal stability which allows it to be printed at a temperature T1 greatly in excess of its melting temperature, making it particularly useful for the present invention.

Preferably, both thermoplastic polymers are PAEK polymers, preferably providing miscibility of the two polymers.

In a preferred embodiment, the thermoplastic polymer of the matrix of the outer layer of prepreg tape or sheet is a PEEK/PEDEK copolymer as described above or a PEEK homopolymer and the feedstock thermoplastic polymer is a PEEK/PEDEK copolymer as described above.

In a particularly preferred embodiment, both thermoplastic polymers are PEEK/PEDEK copolymers as described above.

Suitably, when the thermoplastic polymers are both PAEK polymers, the feedstock thermoplastic polymer has a higher shear viscosity, SV, measured by capillary rheometry at 400° C. and 1000 s⁻¹ than that of the thermoplastic polymer of the matrix of the outer layer of prepreg tape or sheet.

The shear viscosity (SV) of a PAEK polymer or copolymer is suitably measured by capillary rheometry using an RH10 capillary rheometer (Netzsch RH10 capillary rheometer), fitted with a tungsten carbide die (die diameter: 0.5 mm±0.005 mm, die length: 8 mm). The die is mounted at the bottom of the barrel bore, and its dimensions define the applied shear field. A melt pressure transducer is mounted in the barrel to measure the resultant pressure at the die entrance as the material is extruded. Approximately 35 grams of PAEK is placed into an aluminium dish and dried in an air circulating oven for a minimum of 3 hours at 130° C.±5° C. The extruder is allowed to equilibrate to 400° C. and the die is tightened to 37 Nm after allowing heat expansion for 5 minutes. The RH10 transducers are then calibrated and zeroed using the “Flowmaster®” software. The dried polymer is loaded into the heated barrel of the extruder. The test is started by selecting ‘Run Test’ in the software. After an initial 6 minute pre-heat stage, force is applied to the sample according to the test method and the molten polymer is extruded through the die to form a thin fibre. In the ‘Analysis Tab’ of the software, the shear viscosity (Pa·s) is reported at the specified shear rate (1000 s⁻¹ in this case).

When both thermoplastic polymers are PAEK polymers, Tm is suitably from 290° C. to 350° C., preferably from 300° C. to 350° C., T1 is from 340° C. to 450° C. and the outer layer of prepreg tape or sheet of the composite part is suitably at a temperature from (Tm−140) ° C. to (Tm−40) ° C.

The subsequent printing temperature may be less than T1. In other words, after the printing of the first layer, printed with the feedstock at temperature T1, a lower temperature may be used for the feedstock temperature when printing subsequent layers. This feature may be used to improve the polymer crystallinity in subsequent layers and so provide increased mechanical strength compared to printing at higher printing temperatures. The feedstock temperature is typically controlled by varying power to heater cartridges of the printing head. This reduction in temperature may be achieved by cooling of the feedstock material at the printing head, for instance by reducing power to heater cartridges, using ambient air to cause cooling the printing head and/or providing active cooling at the printing head.

A second aspect of the invention provides component having a structure bonded to a composite part;
wherein the composite part is a part comprising one or more layers of consolidated prepreg tape or sheet, wherein each prepreg tape or sheet comprises fibres within a matrix of thermoplastic polymer;
wherein the structure consists of a plurality of layers of feedstock material comprising from 60 to 100% by weight of feedstock thermoplastic polymer, preferably 70 to 100% by weight of feedstock thermoplastic polymer, sequentially printed onto an outer layer of prepreg tape or sheet of the composite part; and
wherein the structure is bonded to the composite part by a melt-bond at a contact region between a first layer of the structure and the outer layer of the prepreg tape or sheet.

The component of the second aspect of the invention may be a component formed by the method of the first aspect of the invention.

The feedstock thermoplastic polymer and the thermoplastic polymer of the matrix of the outer layer of prepreg tape or sheet are suitably compatible or miscible, preferably miscible.

The thermoplastic polymer of the matrix of the outer layer of prepreg tape or sheet of the composite part may be a polyaryletherketone, PAEK polymer or a blend of PAEK polymers, preferably a polyetheretherketone, PEEK, homopolymer and the feedstock thermoplastic polymer may be a polyaryletherketone, PAEK polymer or a blend of PAEK polymers, preferably a polyetherether ketone/polyetherdiphenyletherketone, PEEK/PEDEK, copolymer.

In other words, both the thermoplastic polymer of the matrix of the outer layer of prepreg tape or sheet of the composite part and the feedstock thermoplastic polymer are preferably each PEAK polymers, preferably providing miscibility of the two polymers.

In a preferred embodiment, the thermoplastic polymer of the matrix of the outer layer of prepreg tape or sheet is a PEEK/PEDEK copolymer as described above, or a PEEK homopolymer, and the feedstock thermoplastic polymer is a PEEK/PEDEK copolymer as described above.

In a particularly preferred embodiment, both thermoplastic polymers are PEEK/PEDEK copolymers as described above.

Preferably, when both the thermoplastic polymer of the matrix of the outer layer of prepreg tape or sheet of the composite part and the feedstock thermoplastic polymer are each PEAK polymers, the feedstock thermoplastic polymer has a shear viscosity, SV, measured by capillary rheometry at 400° C. and 1000 s⁻¹ which is greater than the SV of the thermoplastic polymer of the matrix of the outer layer of prepreg tape or sheet of the composite part, measured by capillary rheometry at 400° C. and 1000 s⁻¹. The SV measurement is made as already described above.

Preferably, the feedstock thermoplastic polymer has a melting temperature which is less than the melting temperature Tm of the thermoplastic polymer of the matrix of the outer layer of prepreg tape or sheet of the composite part.

The following Example provides a non-limiting embodiment of the invention.

A 2 mm thick sheet of PEEK/PEDEK/woven carbon-fibre laminate was mounted on the base-plate of a conventional Fused Filament Fabrication (FFF) printer. The base plate and laminate sheet were heated to 110° C. An aluminium support plate, also having 2 mm thickness, was placed adjacent to and abutting the laminate sheet to act as a support for a tab structure to be FFF printed onto the substrate and extending past the edge of the substrate.

The tab was formed by FFF printing of a PEEK/PEDEK filament at 380° C. print temperature (T1) with a filament feed rate of 1 mm/s.

The bonding of the resulting tab to the underlying laminate sheet was found to have high strength, capable of supporting a load in excess of 1200 N.

The PEEK/PEDEK copolymer of the printed filament and of the matrix of the laminate consisted essentially of EEK and EDEK monomers, with no other monomers included, in the molar ratio 75:25. The SV of the copolymer (measured as described herein at 400° C. and 1000 s⁻¹ shear rate) was 250 Pa·s. Its melting temperature was 303° C., measured by DSC as described herein.

In summary, the invention provides a method of forming a component having a structure bonded to a composite part formed from prepreg tape or sheet having fibres within a matrix of thermoplastic polymer involves printing multiple layers of a feedstock material comprising at least 60% by weight of thermoplastic polymer, preferably at least 70% by weight of thermoplastic polymer onto the composite part to form the structure. At least the first layer of the structure is printed with the feedstock material at a temperature in excess of the melting temperature of the prepreg polymer. The method provides strong melt-bonding of the structure to the composite part. A component having a structure of sequentially printed layers melt-bonded to a composite part is also provided.

The described and illustrated embodiments are to be considered as illustrative and not restrictive in character, it being understood that preferred embodiments have been shown and described and that all changes and modifications that come within the scope of the inventions as defined in the claims are desired to be protected. It should be understood that while the use of words such as “preferable”, “preferably”, “preferred” or “more preferred” in the description suggest that a feature so described may be desirable, it may nevertheless not be necessary and embodiments lacking such a feature may be contemplated as within the scope of the invention as defined in the appended claims. In relation to the claims, it is intended that when words such as “a,” “an,” “at least one,” or “at least one portion” are used to preface a feature there is no intention to limit the claim to only one such feature unless specifically stated to the contrary in the claim.

1. A method of forming a component having a structure bonded to a composite part, wherein the composite part is a part formed of one or more layers of consolidated prepreg tape or sheet, wherein each prepreg tape or sheet comprises fibres within a matrix of thermoplastic polymer, the method comprising the following steps:
a) selecting a feedstock material comprising 60 to 100% by weight of feedstock thermoplastic polymer;
b) extruding the feedstock material through an exit orifice of a printing head to form a first layer of the structure printed onto an outer layer of prepreg tape or sheet of the composite part, with the feedstock polymer in a molten state and at a first printing temperature T1 at the exit orifice; and
c) extruding the feedstock material through the exit orifice to form a second layer and subsequent layers of the structure, with the second and subsequent layers printed onto a respective preceding layer of the structure, until the structure is complete, with the feedstock polymer in a molten state at the exit orifice at a subsequent printing temperature;
wherein T1 is greater than the melting temperature, Tm, of the thermoplastic polymer of the matrix of the outer layer of prepreg tape or sheet of the composite component so that at least a portion of the thermoplastic polymer of the matrix of the outer layer of prepreg tape or sheet is melted by contact with the first layer of the structure to form a melt-bond between the first layer of the structure and the outer layer of prepreg tape or sheet.

2. The method according to claim 1 wherein the outer layer of prepreg tape or sheet of the composite part is at a temperature from (Tm−140) ° C. to (Tm−40) ° C.

3. The method according to claim 1 wherein T1 is greater than Tm by 20° C. or more and less than the thermal decomposition onset temperature of the feedstock thermoplastic polymer by 20° C. or more.

4. The method according to claim 1 wherein the feedstock thermoplastic polymer has a melting temperature which is lower than Tm.

5. The method of claim 1 wherein the feedstock thermoplastic polymer and the thermoplastic polymer of the matrix of the outer layer of prepreg tape or sheet are compatible or miscible.

6. The method according to claim 1 wherein the thermoplastic polymer of the matrix of the outer layer of prepreg tape or sheet is a polyaryletherketone, PAEK polymer or a blend of PAEK polymers and wherein the feedstock thermoplastic polymer is a polyaryletherketone, PAEK polymer or a blend of PAEK polymers.

7. The method of claim 6 wherein the thermoplastic polymer of the matrix of the outer layer of prepreg tape or sheet is a PEEK/PEDEK copolymer or a PEEK homopolymer and wherein the feedstock thermoplastic polymer is a PEEK/PEDEK copolymer.

8. The method according to claim 6 wherein the feedstock thermoplastic polymer has a higher shear viscosity, SV, measured by capillary rheometry at 400° C. and 1000 s⁻¹ than that of the thermoplastic polymer of the matrix of the outer layer of prepreg tape or sheet.

9. The method according to claim 6 wherein Tm is from 290° C. to 350° C., T1 is from 340° C. to 450° C. and wherein the outer layer of prepreg tape or sheet of the composite part is at a temperature from (Tm−140) ° C. to (Tm−40)° C.

10. The method according to claim 1 wherein the subsequent printing temperature is less than T1.

11. A component having a structure bonded to a composite part;
wherein the composite part is a part is a part comprising one or more layers of consolidated prepreg tape or sheet, wherein each prepreg tape or sheet comprises fibres within a matrix of thermoplastic polymer;
wherein the structure consists of a plurality of layers of feedstock material comprising from 60 to 100% by weight of feedstock thermoplastic polymer sequentially printed onto an outer layer of prepreg tape or sheet of the composite part; and
wherein the structure is bonded to the composite part by a melt-bond at a contact region between a first layer of the structure and the outer layer of the prepreg tape or sheet.

12. The component of claim 11 wherein the feedstock thermoplastic polymer and the thermoplastic polymer of the matrix of the outer layer of prepreg tape or sheet are compatible or miscible.

13. A component according to claim 11 wherein the thermoplastic polymer of the matrix of the outer layer of prepreg tape or sheet of the composite part is a polyaryletherketone, PAEK polymer or a blend of PAEK polymers, and wherein feedstock thermoplastic polymer is a polyaryletherketone, PAEK polymer or a blend of PAEK polymers.

14. A component according to claim 13 wherein the feedstock thermoplastic polymer has a shear viscosity, SV, measured by capillary rheometry at 400° C. and 1000 s⁻¹ which is greater than the SV of the thermoplastic polymer of the matrix of the outer layer of prepreg tape or sheet of the composite part, measured by capillary rheometry at 400° C. and 1000 s⁻¹.

15. A component according to claim 11 wherein the feedstock thermoplastic polymer has a melting temperature which is less than the melting temperature Tm of the thermoplastic polymer of the matrix of the outer layer of prepreg tape or sheet of the composite part.

16. The method of claim 5 wherein the feedstock thermoplastic polymer and the thermoplastic polymer of the matrix of the outer layer of prepreg tape or sheet are miscible.

17. The component of claim 12 wherein the feedstock thermoplastic polymer and the thermoplastic polymer of the matrix of the outer layer of prepreg tape or sheet are miscible.
